(19) United States
(12) Patent Application Publication
(10) Pub. No.: US 2015/0019601 A1
(43) Pub. Date: Jan. 15, 2015

(54) PROVIDING NETWORK ATTACHED STORAGE DEVICES TO MANAGEMENT SUB-SYSTEMS

(71) Applicants: Richard Wei Chieh Yu, Spring, TX (US); Andrew Brown, Houston, TX (US); Luis E. Luciani, JR., Tomball, TX (US); Erik Levon Young, Houston, TX (US)

(72) Inventors: Richard Wei Chieh Yu, Spring, TX (US); Andrew Brown, Houston, TX (US); Luis E. Luciani, JR., Tomball, TX (US); Erik Levon Young, Houston, TX (US)

(21) Appl. No.: 14/370,058

(22) PCT Filed: Jan. 30, 2012
(86) PCT No.: PCT/US12/23119

§ 371 Date: Jun. 30, 2014

(51) Int. Cl. G06F 17/30; H04L 29/08

(52) U.S. Cl. CPC G06F 17/30203; H04L 67/1097
USPC 707/827

(57) ABSTRACT

Systems, methods, and computer-readable and executable instructions are provided for providing network attached storage (NAS) devices 232 to management sub-systems 214. Methods for providing a NAS device 232 to a management sub-system 214 can include implementing a network file system (NFS) 220 within the management sub-system 214, 102. Providing a NAS device 232 to a management sub-system 214 also can include communicatively coupling the NFS 220 and the NAS device 232, 104. Furthermore, providing a NAS device 232 to a management sub-system 214 can include providing the management sub-system 214 access to the NAS device 232 via the implemented NFS 220, 106.

### BACKGROUND

A network server can utilize a management sub-system to perform computational tasks. A management sub-system can be utilized to monitor and/or control physical memory in a computer system.

### BRIEF DESCRIPTION OF THE DRAWINGS

FIG. 1 illustrates a flow chart illustrating an example method for providing a network attached storage (NAS) device to a management sub-system according to the present disclosure.

FIG. 2 illustrates an example diagram representing a system for providing a network attached storage (NAS) device to a management sub-system according to the present disclosure.

### DETAILED DESCRIPTION

Examples of the present disclosure include methods, systems, and computer-readable and executable instructions for providing network attached storage (NAS) devices to management subsystems. Methods for providing a NAS device to a management sub-system can include implementing a network file system (NFS) within the management sub-system. Providing a NAS device to a management sub-system also can include communicatively coupling the NFS and the NAS device. Furthermore, providing a NAS device to a management sub-system can include providing the management sub-system access to the NAS device via the implemented NFS.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

A management sub-system can be utilized to perform various computational tasks (e.g., control physical memory in a computer system, monitor physical memory, and/or monitor computer processors, among other computational tasks). A management sub-system can be implemented in or communicatively coupled to a server. A management sub-system can lack, or have limited, storage capacity. The lack of, or limited, storage capacity can prevent the management sub-system from enabling applications (e.g., event logging). By implementing a network file system (NFS) within the management sub-system, the management sub-system can have access to a NAS device. The management sub-system can utilize the access to a NAS device to enable applications.

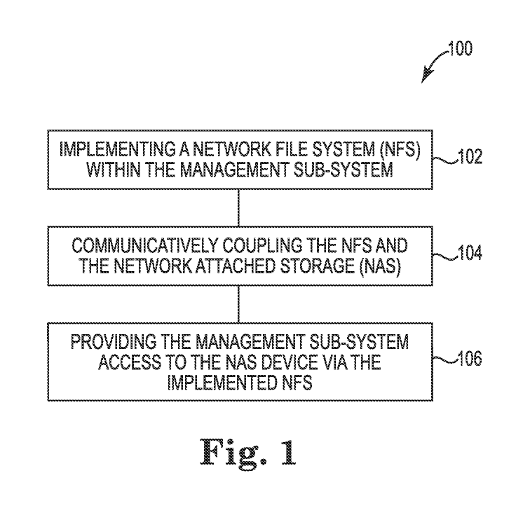

FIG. 1 illustrates a flow chart illustrating an example method 100 for providing a NAS device to a management sub-system according to the present disclosure. The method 100 can be utilized to provide a management sub-system access to a NAS device. The management sub-system can utilize the NAS device in various ways (e.g., event logging, data storage, virtual media access, among other applications that require mass storage).

At 102, a NFS is implemented into a management sub-system. The NFS can allow a computing device to access files (e.g., directories, system files, among other files) over a network. The NFS can allow a computing device to access and share files on a remote system (e.g., as if the files were local files on the computing device).

Implementing the NFS into the management sub-system can include a set up that allows the management sub-system to utilize the NFS. Implementation can also include a set up that allows the management sub-system to access a NAS device via the NFS. The implementation and set up can be different for various servers (e.g., iLO4® by Hewlett-Packard (HP), among other servers). The implementation and set up can also be different for various versions of software (e.g., Windows 7®, among other software versions) being utilized within the server.

A management sub-system can be a baseboard management controller (BMC). A management sub-system can be a specialized service processor that monitors a state (e.g., physical state) of a computing device (e.g., computer, network server, hardware, etc.) using sensors. In addition, a management sub-system can communicate with a system administrator to communicate the state (e.g., state of the computing device). Furthermore, a management sub-system can be located in various locations (e.g., in a motherboard, processor, etc.) within a computing device (e.g., a server).

At 104, the NFS is communicatively coupled to the NAS device. This coupling can allow the management sub-system to access the NAS device. Coupling can include a network file system protocol. The network file system protocol can, for example, allow the management sub-system to access the NAS device as if it were local memory to the management sub-system. For example, the NFS can be electronically coupled (e.g., via Ethernet, local area network (LAN), wide area network (WAN), personal area network (PAN), Wi-Fi®) to the NAS device and the NFS can utilize a network file system protocol to communicate with the NAS device.

At 106, the management sub-system is provided access to the NAS device via the NFS. The NFS can, for example, provide the management sub-system access to the NAS device as if it were local storage. The management sub-system can utilize the NAS device to enable various applications. For example, the management sub-system can enable event logging. Event logging can include writing data to the NAS device concerning the event data of the physical state of the computing device. The event logging can also include writing related data to the event data of the physical state in the memory of the NAS device. For example, data related to the event can include, but are not limited to: the location, the date, the frequency of the event, the damage, and/or the urgency of repair.

The management sub-system can enable applications such as opening a the descriptor saved within the NAS device. A the descriptor can, for example, be an abstract indicator for accessing a file. For example, a file descriptor can be an index for an entry in a kernel-resident data structure containing the details of open files.

The management sub-system can open a the descriptor and write data in a the stored within the NAS device. For example, the management sub-system can write data in a the pertaining to the physical state of the computing device.

The management sub-system can open a file descriptor and read data in a file stored within the NAS device. For example, the management sub-system can read the data that has been collected and written pertaining to the physical state of the computing device.

The NAS device can, for example, be mapped and utilized as physical memory for virtual media that is within the management sub-system. The virtual media can be accessed by a client/user via an internet protocol (e.g., http protocol, among others). The management sub-system, for example, can utilize the NAS device to distribute physical memory to the various virtual media within the management sub-system.

The NAS device can contain a file in an International Organization for Standardization format (ISO file). An ISO file can be an archive file. The ISO file can, for example, be composed of the data contents of every written sector of an optical device. The ISO file can, for example, be created from an optical disc or from a collection of files.

The method 100 can resolve a limitation, or lack of, storage capacity in the management sub-system and can simplify the management subsystem virtual media data access. The method 100 can be a cost effective way to provide mass storage capacity to a management sub-system compared to, for example, utilizing embedded flash parts for storage. The method 100 can remove the need for a proprietary client application in virtual media. Furthermore, the method 100 can be less processing intensive when compared to utilizing an internet protocol for storage.

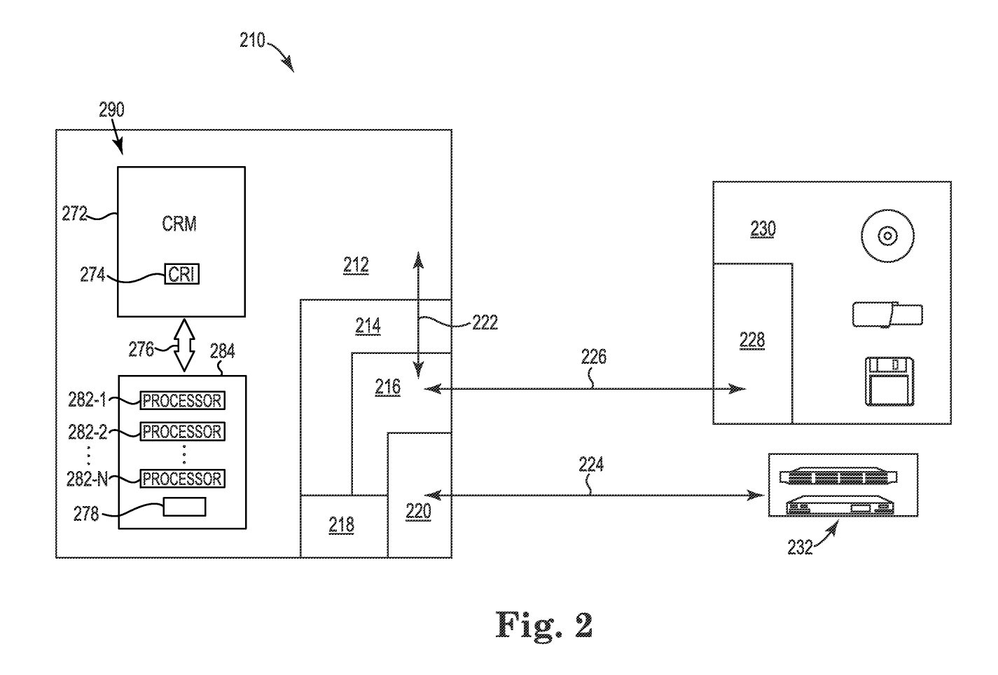

FIG. 2 illustrates an example diagram representing a system 210 for providing a NAS device 232 to a management sub-system 214 according to the present disclosure.

A server 212 can include various hardware and software components. For example, the server 212 can include a management sub-system 214. As described herein, the management sub-system 214 can be a BMC, for example, and can perform various functions within the server 212.

The management sub-system 214 can be implemented with various hardware and/or software components. For example, the management sub-system 214 can be implemented with a NFS 220. As described herein, the NFS 220 can provide the management sub-system 214 access to a NAS device 232, for example, as if it were local storage within the management sub-system. The NFS 220 can communicate and/or access data from the NAS device 232 via a NFS protocol 224. The NFS 220 can provide the management sub-system 214 with access to the NAS device 232.

The management sub-system 214 can utilize the NAS device 232 to enable various applications 218. The management sub-system can, for example, utilize the NAS device 232 to enable event logging. For example, the management sub-system can utilize the NAS device 232 to write/read event data on the NAS device 232.

The management sub-system 214 can, for example, be implemented with virtual media 216. Virtual media 216 can be enabled to allow a user to access virtual memory. Virtual media 216 can be a memory management technique that can virtualize various forms of data storage (e.g., NAS device 232, random access memory (RAM), disk storage, etc.). In some examples, the virtual media 216 can utilize data sourcing to retrieve data directly from the NAS device 232. Data sourcing can be retrieving information data from various sources.

The virtual media 216 can be implemented by an electronic connection 222 (e.g., a universal serial bus (USB), Ethernet, among others) to the server 212. The virtual media 216 can utilize a physical memory (not shown) within the server 212 to provide virtual memory to a client system 230. The client system 230 can include a computing device able to access a number of computer readable media (e.g., compact disk, solid state memory, RAM, remote hard drive, among others).

The client system 230 can be connected to the virtual media via a webserver 228 (e.g., an internet relay chat (IRC) webserver, among other web servers). The webserver 228 can include various other communication devices and utilize other internet protocols (e.g., JIRC webserver, among others). The webserver 228 can, for example, communicate with the virtual media 216 via an internet protocol (e.g., http protocol, among others) 226. The webserver 228 can be implemented in the client system 230 and provide virtual memory from the virtual media 216 to the various parts of the client system 230.

The system 210 shown in FIG. 2 further illustrates a block diagram 290 of an example of a computer-readable medium (CRM) 272 in communication with processing resources 282-1 282-2, . . . , 282-N, for providing the NAS device 232 to the management sub-system 214. Block diagram 290 is represented within the server 212. Block diagram 290 can also be implemented outside of the server 212, either communicatively coupled to the server 212 and/or performed by a different computing device.

CRM 272 can be in communication with a computing device 284 (e.g., a Java® application server, among others) having processor resources of more or fewer than 282-1, 282-2, . . . , 282-N. The computing device 284 can be in communication with a tangible non-transitory CRM 272 storing a set of computer-readable instructions (CRI) 274 executable by one or more of the processor resources 282-1, 282-2, 282-N, as described herein. The computing device 284 can include memory resources 278, and the processor resources 282-1, 282-2, . . . , 282-N can be coupled to the memory resources 278.

Processor resources 282-1, 282-2, . . . , 282-N can execute CRI 274 that can be stored on an internal or external non-transitory CRM 272. A non-transitory CRM (e.g., CRM 272), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory CRM 272 can be integral, or communicatively coupled, to a computing device, in a wired and/or a wireless manner. For example, the non-transitory CRM 272 can be an internal memory, a portable memory, a portable disk, or a memory associated with another computing resource (e.g., enabling computer-readable instructions to be transferred and/or executed across a network such as the Internet).

The CRM 272 can be in communication with the processor resources 282-1, 282-2, . . . , 282-N via a communication path 276. The communication path 276 can be local or remote to a machine (e.g., a computer) associated with the processor resources 282-1, 282-2, . . . , 282-N. Examples of a local communication path 276 can include an electronic bus internal to a machine (e.g., a computer) where the CRM 272 is one of volatile, non-volatile, fixed, and/or removable storage medium in communication with the processor resources 282-1, 282-2, . . . , 282-N via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 276 can be such that the CRM 272 is remote from the processor resources e.g., 282-1, 282-2, . . . , 282-N, such as in a network connection between the CRM 272 and the processor resources (e.g., 282-1, 282-2, . . . , 282-N). That is, the communication path 276 can be a network connection. Examples of such a network connection can include a LAN, WAN, PAN, and the Internet, among others. In such examples, the CRM 272 can be associated with a first computing device and the processor resources 282-1, 282-2, . . . , 282-N can be associated with a second computing device (e.g., a Java® application server).

The processor resources 282-1, 282-2, . . . , 282-N coupled to the memory 278 can enable the NFS 220 to be implemented in a management sub-system 214. The processor resources 282-1, 282-2, . . . , 282-N coupled to the memory 278 can also access the NAS device 232 utilizing the NFS 220. Furthermore, the processor resources 282-1, 282-2, . . . , 282-N coupled to the memory 278 can utilize the NAS device 232 for management sub-system applications 218 (e.g., event logging, among other applications).

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor,

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for providing a network attached storage (NAS) device to a management sub-system, comprising:
implementing a network the system (NFS) within the management sub-system;
communicatively coupling the NFS and the NAS device; and
providing the management sub-system access to the NAS device via the implemented NFS.

2. The method of claim 1, wherein providing the management sub-system access to the NAS device further comprises allowing the management sub-system to enable applications.

3. The method of claim 2, wherein allowing the management sub-system to enable applications comprises event logging.

4. The method of claim 2, wherein allowing the management sub-system to enable applications comprises opening a file descriptor and reading data from a file stored in the NAS device.

5. The method of claim 2, wherein allowing the management sub-system to enable applications comprises opening a file descriptor and writing data in a file stored in the NAS device.

6. A non-transitory computer-readable medium storing a set of instructions executable by a processor to cause a computer to:
access a network attached storage (NAS) device that is communicatively coupled to a network file system (NFS), wherein the NFS is implemented in a management sub-system;
enable the management sub-system to run applications utilizing the NAS device; and
open a file descriptor from a file stored in the NAS device.

7. The medium of claim 6, wherein applications comprise event logging.

8. The medium of claim 6, wherein the NAS device is utilized as physical storage for virtual media.

9. The medium of claim 6, wherein the management sub-system reads data stored in the NAS device.

10. The medium of claim 9, wherein the management sub-system writes data stored in the NAS device.

11. A computing system, comprising:
a memory; and
a processor resource coupled to the memory, to:
enable a network file system (NFS) implemented in a management sub-system;
access a network attached storage (NAS) device utilizing the NFS; and
utilize the NAS device for management sub-system applications.

12. The computing system of claim 11, wherein the management sub-system provides a virtual media and is communicatively connected to a client system via on http protocol.

13. The computing system of claim 12, wherein the NAS device is mapped to provide storage for the virtual media.

14. The computing system of claim 11, wherein a file in an International Organization for Standardization format (ISO) is stored in the NAS device.

15. The computing system of claim 11, wherein the virtual media is implemented in the management sub-system and the virtual media sources data directly from the NAS device.
